(19) United States
(12) Patent Application Publication
(10) Pub. No.: US 2018/0145904 A1
(43) Pub. Date: May 24, 2018

(54) SYSTEM OF HIERARCHICAL FLOW-PROCESSING TIERS

(71) Applicant: Radisys Corporation, Hillsboro, OR (US)

(72) Inventors: Andrew Alleman, Portland, OR (US); Prashant Sharma, San Diego, CA (US)

(21) Appl. No.: 15/435,131

(22) Filed: Feb. 16, 2017

Related U.S. Application Data
(60) Provisional application No. 62/425,467, filed on Nov. 22, 2016.

(51) Int. Cl. H04L 12/713; H04L 12/715; H04L 12/803

(52) U.S. Cl. CPC H04L 45/586; H04L 47/125; H04L 45/64

(57) ABSTRACT

A flow-processing hierarchical system including four hierarchical levels (also called tiers) is disclosed. Each hierarchical level of processing handles increasingly higher levels of computational complexity and flexibility at a gradual corresponding reduction in throughput.

### RELATED APPLICATION

This application claims the benefit of U.S. Provisional Patent Application No. 62/425,467, filed Nov. 22, 2016, which is incorporated herein by reference.

### TECHNICAL FIELD

The field of the present disclosure relates generally to processing datapath flows and, more particularly, to techniques for processing datapath flows using a hierarchical system of flow-processing devices or logical tiers.

### BACKGROUND INFORMATION

In packet switching networks, traffic flow, (data) packet flow, network flow, datapath flow, or simply flow is a sequence of packets, typically of an internet protocol (IP), conveyed from a source computer to a destination, which may be another host, a multicast group, or a broadcast domain. Request for Comments (RFC) No. 2722 (RFC 2722) defines traffic flow as “an artificial logical equivalent to a call or connection.” RFC 3697 defines traffic flow as “a sequence of packets sent from a particular source to a particular unicast, anycast, or multicast destination that the source desires to label as a flow. A flow could consist of all packets in a specific transport connection or a media stream. However, a flow is not necessarily 1:1 mapped to a transport connection [i.e., under a Transmission Control Protocol (TCP)].” Flow is also defined in RFC 3917 as “a set of IP packets passing an observation point in the network during a certain time interval.”

With ever growing volumes, speeds, and network capacity requirements—particularly for mobile terminated or mobile originated data—network operators seek to manage the growing variety of data flows originating from various users or data centers. Thus, network operators have come to expect intelligence in their core network functions so as to manage flows more efficiently through the network. Intelligent traffic distribution functionality, therefore, is increasingly being deployed using network functions virtualization (NFV) and software defined networking (SDN).

### SUMMARY OF THE DISCLOSURE

Disclosed is a system, which may be embodied as a monolithic network appliance, including multiple hierarchical flow-processing tiers (i.e., levels of processing entities) responsible for substantially distinct logical partitions of granular flow-processing at each level (i.e., tier) of the hierarchy. Each level of the hierarchy is defined by a corresponding entity—be it a logical or physical entity—that carries out a flow-processing task optimized for its particular level in the hierarchy. Thus, an upper level handles increasingly computationally intensive (i.e., application specific, complex, and programmable) flow-processing relative to lower levels of the hierarchy. And flow-processing throughput is decreasingly accelerated at an upper level relative to lower levels. In other words, the computational intensity and the volume are inversely related to each other across the levels of the hierarchical system.

In certain embodiments, the associated processing hardware of the system also reflects an inverse relationship as the tiers progress up the hierarchy, e.g., from—at a lowest, base level—switching application-specific integrated circuit (ASIC) chips, to a network flow processor (NFP) or a network processing unit (NPU), to an integrated system on a chip (SoC) central processing unit (CPU), and finally—at the highest, apex level—to a general purpose compute server.

The disclosed embodiments provide a balanced blend of highly granular flow awareness, selective application processing, and high-performance networking input-output (I/O), all of which are maintained under flexible programmable control.

Additional aspects and advantages will be apparent from the following detailed description of embodiments, which proceeds with reference to the accompanying drawings.

### BRIEF DESCRIPTION OF THE DRAWINGS

FIG. 1 is a block diagram of a system of hierarchical flow-processing tiers, according to one embodiment.

FIG. 2 is a load balancer configurable according to certain embodiments.

FIG. 3 is a simplified version of the block diagram of FIG. 1 showing an example packet flow direction with load balancing applied by the load balancer of FIG. 2, according to one embodiment.

FIG. 4 is a sequence diagram showing the load balancing process of FIGS. 2 and 3 handling an example pair of packet flows, according to one embodiment.

FIG. 5 shows a pair of block diagrams showing arrangements of tiers for traffic distribution engine (TDE) products including, respectively, TDE-500 and TDE-2000 products available from Radisys Corporation of Hillsboro, Oreg., according to example embodiments.

FIGS. 6, 7, and 8 are block diagrams showing example rules of, respectively, a packet forwarding entity, a network processing entity, and directing processing and adjunct application entities.

### DETAILED DESCRIPTION OF EMBODIMENTS

Previous attempts to improve network intelligence have entailed packet classification, which involves quickly looking inside each packet, past its header information, and into the actual packet contents so as to identify each unique flow. A challenge for network engineers, however, is that wire-speed packet classification assumes very high processing performance.

Attempts to deliver rapid packet classification and traffic distribution to the appropriate virtualized network function (VNF) have entailed allowing the VNFs (i.e., at an NFV data center) to perform packet classification and load balancing and thereby determine whether each packet flow is relevant to each VNF. But this approach limits processing power—across hundreds of VNFs—available for performing the actual processing of the underlying VNF application. Another approach to improve network intelligence entails consolidating some aspects of packet classification and load balancing into network equipment that is between the core network and the NFVs. This approach potentially frees up computing power on the servers so that they may focus on the underlying VNF application processing, thereby improving the efficiency of the computing power in NFV architecture.

Currently, aspects of packet classification and load balancing are still spread out amongst disparate router, switch, and load balancer equipment, which results in high-cost complexity with little or no flexible SDN control. Rudimentary attempts at enhancing intelligent traffic distribution systems have entailed providing marginal optimizations of the aforementioned disparate components that collectively lack overall flow awareness. For example, a basic switch ASIC, which may have some rudimentary programmability for a limited number for flows, lacks flexibility, scalability, and flow awareness to handle a relatively large volume of flows. As the number of flows increase, e.g., to hundreds of millions of flows, a fixed ASIC simply does not scale. Similarly, at the other end of the spectrum (in terms of higher processing complexity), conventional devices such as load balancers with deep packet analysis capability lack the speed of an ASIC. In other words, a rudimentary aggregation of such separately optimized devices could not handle immense traffic and, therefore, they have not been combined into a common platform for at least the following four reasons.

First, conventional attempts to employ programmable devices for high-speed switching had—relative to non-programmable ASICs—insufficient processing performance and I/O speeds. These deficiencies have made it challenging to quickly divert some aspects of processing to a higher-level processing tier because there was simply too big of a gap (in terms of throughput) between programmable and non-programmable devices. That gap has inhibited an ability to efficiently employ programmable and non-programmable devices in different hierarchical tiers of a common network appliance. For example, ASICs, which are capable of handling about one terabit per second (Tb/s), may aggregate 20-40 I/O ports, each of which is capable of speeds of 10-100 gigabits per second (Gbps, Gb/s, or simply, “G”), for a net throughput of one to several Tb/s. (Note that these speeds are merely examples, as skilled persons will appreciate that port speeds regularly improve. Compare a TDE-500 implementation, which has an ASIC supporting 24×40G for a total of 960 Gb/s; a TDE-2000 implementation, which has an ASIC supporting 32×100G for a total of 3.2 Tb/s; and newer ASICs are expected to reach throughput speeds of 6.4 Tb/s.) Nevertheless, the aforementioned gap between the ASICs and more flexible processing devices is significant: previous NFPs and CPUs performed at throughput rates of about, respectively, 100 and 10 Gb/s and therefore could not interface well with ASICs.

Second, for a similar reason as the previous one (albeit for a higher level of processing), a lack of sufficient packet processing in CPUs also resulted in a gap between NPUs and CPUs that is also too big. The CPUs of this disclosure, however, have substantially improved I/O capacity and packet performance, now handling about 20-50 Gb/s per socket (device).

Third, prior attempts had insufficient network switch I/O capacity to maintain useful port counts for a hierarchical arrangement of processing tiers. In other words, using a switch ASIC as the lowest tier would not work well if too much I/O is consumed in connecting to the next tier (i.e., a network processing tier described later). For example, a 480G network switch available from Broadcom Limited of Singapore and San Jose, Calif. had 10G and 40G I/O but an insufficient number of ports to provide a fully symmetric implementation. Thus, if a user connected, for example, 2×160 Gb/s to the NPUs (i.e., for 320 Gb/s throughput), there was little I/O capacity remaining by which to provide external network connectivity. In contrast, more recent switching ASICs are fully symmetric without so-called grouping limitations of previous generations.

Fourth, conventional attempts had a lack of standardized or normalized control plane mechanisms by which to define data plane processing. This is so because previous approaches for network switches tended to be monolithic, i.e., including the control plane embedded on the network element. On the other hand, SDN controllers (and interface protocols) include standardized or normalized techniques for externally programmable data plane management. Accordingly, SDN interfaces (e.g., under the OpenFlow or ForCES [RFC 5810] standards) expose rules that can be programmed from a separate external entity, outside of the network element being programmed. This allows the control plane to be disaggregated from the data plane, and the data plane (e.g., of the type disclosed herein) may be fully optimized for this function.

The present disclosure describes techniques realizing advantages of increases in CPU and NPU processing capabilities and ASIC connectivity (e.g., higher port counts allowing connection of multiple NPUs to a switch) and alleviating the aforementioned gaps and issues through the described tiered processing systems and methods beginning with, e.g., the TDE-500 platform. More generally, the techniques of the present disclosure address existing technical deficiencies, providing performance of a fixed hardware-based solution, yet with the flexibility of a software-based solution. In other words, hierarchical tiers establish smooth transitions between ASIC functionality and more flexible software-based processing functionality. Thus, the present disclosure describes techniques for enhancing intelligent traffic distribution systems by processing datapath flows using a hierarchical system of flow-processing devices in a common platform that communicatively couples the levels. According to some embodiments, there are different levels of specificity by which to handle the processing of different Open Systems Interconnection (OSI) model layers from layer one (physical layer, L1) through layer seven (application layer, L7), i.e., L1-L7, thereby providing a system capable of taking a flow through any number of the levels—from the lowest, fastest pass (i.e., the least amount of processing and the highest throughput) level through any number of increasingly higher, slower-pass processing levels.

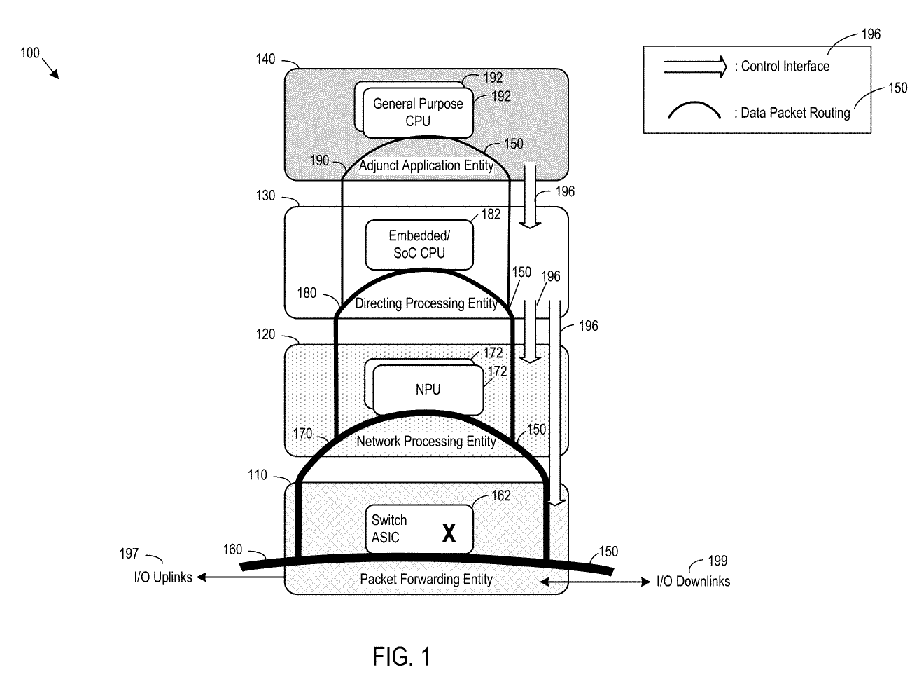

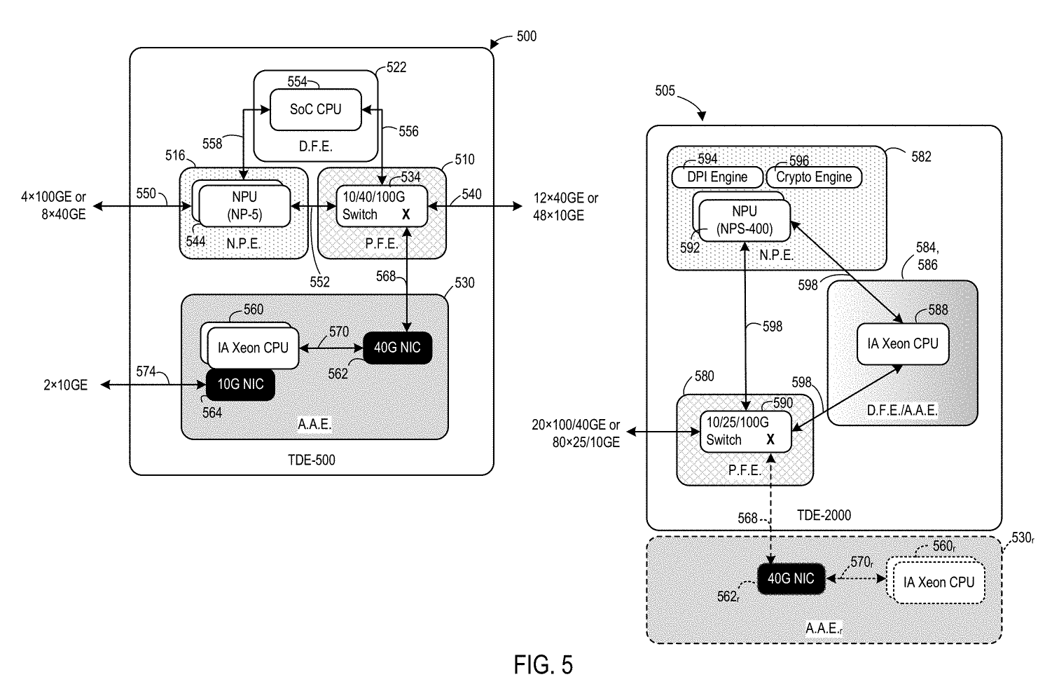

FIG. 1 shows a flow-processing hierarchical system 100 including four hierarchical levels (also called tiers). Each hierarchical level of processing handles increasingly higher levels of computational complexity and flexibility at a gradual corresponding reduction in flow-processing throughput. In the system 100, four levels correspond to four different entities: a packet forwarding entity 110, a network processing entity 120, a directing processing entity 130, and an adjunct application entity 140. In some embodiments, these are separate physical entities in the sense that each entity and its associated flow-processing task(s) are implemented by a separate hardware device, e.g., a processor—such as a microprocessor, microcontroller, logic circuitry, or the like—and associated electrical circuitry, which may include a computer-readable storage device such as non-volatile memory, static random access memory (RAM), dynamic RAM (DRAM), read-only memory (ROM), flash memory, or other computer-readable storage medium. In other embodiments, however, multiple entities may be implemented in common hardware such that software establishes a logical separation between the multiple entities. Accordingly, entities need not be separate physical entities in some embodiments (see, e.g., the upper pair of levels of the TDE-2000 platform shown in FIG. 5).

As shown in FIG. 1, data packet routes 150 through the flow-processing hierarchical system 100 are represented as solid, arcuate lines having line weights proportional to relative amounts of available throughput. The data packet routes 150 are as follows: first is a data packet route 160 through a switch ASIC 162; second is a data packet route 170 through multiple NPUs 172; third is a data packet route 180 through a local management processor (LMP) (e.g., an SoC CPU) 182; and fourth is a data packet route 190 to or through adjunct servers implemented by general purpose CPUs 192. Also, control interface paths 196 are represented by unfilled arrows indicating instantiation, in the lower levels, of rules employed in fast, scalable tables.

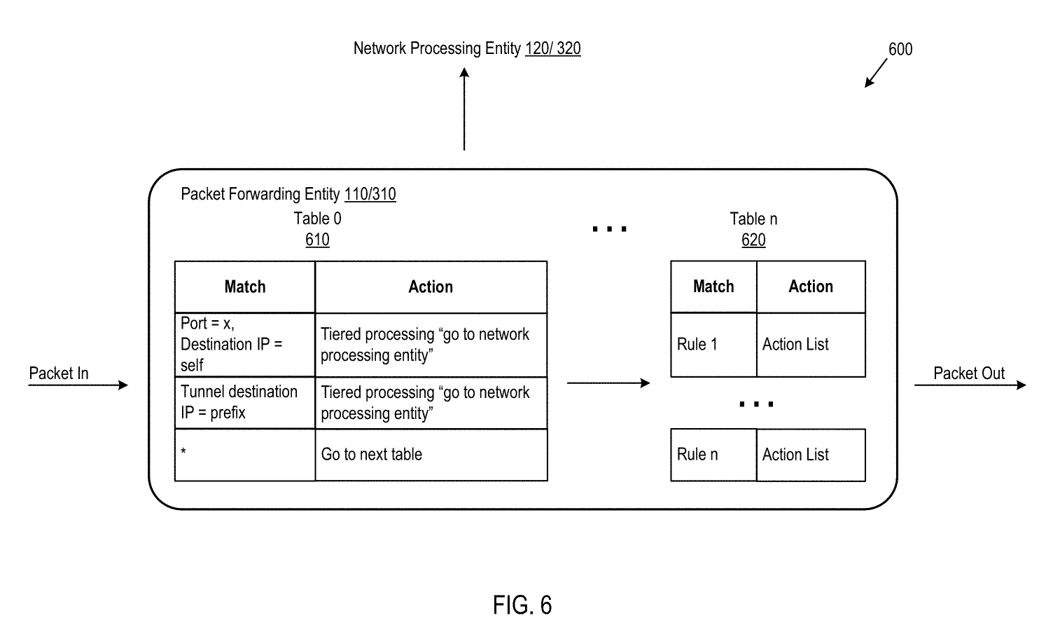

The packet forwarding entity 110 is the first (base) level that includes the switch ASIC 162, I/O uplinks 197, and I/O downlinks 199. The packet forwarding entity 110 is characterized by layer two (data link layer, L2) or layer three (network layer, L3) (generally, L2/L3) stateless forwarding, relatively large I/O fan-out, autonomous L2/L3 processing, highest performance switching or routing functions at line rates, and generally less software-implemented flexibility. Data packets designated for local processing are provided to the network processing entity 120. Accordingly, the base level facilitates, in an example embodiment, at least about one Tb/s I/O performance (e.g., about one Tb/s in the TDE-500 instantiation, about three Tb/s in the TDE-2000, and increasing terabit throughput for successive generations) while checking data packets against configurable rules to identify which packets go to the network processing entity 120. For example, the first level may provide some data packets to the network processing entity 120 in response to the data packets possessing certain destination IP or media access control (MAC) information, virtual local area network (VLAN) information at the data link layer, or other lower-level criteria set forth in a packet forwarding rule, examples of which are set forth in FIG. 6.

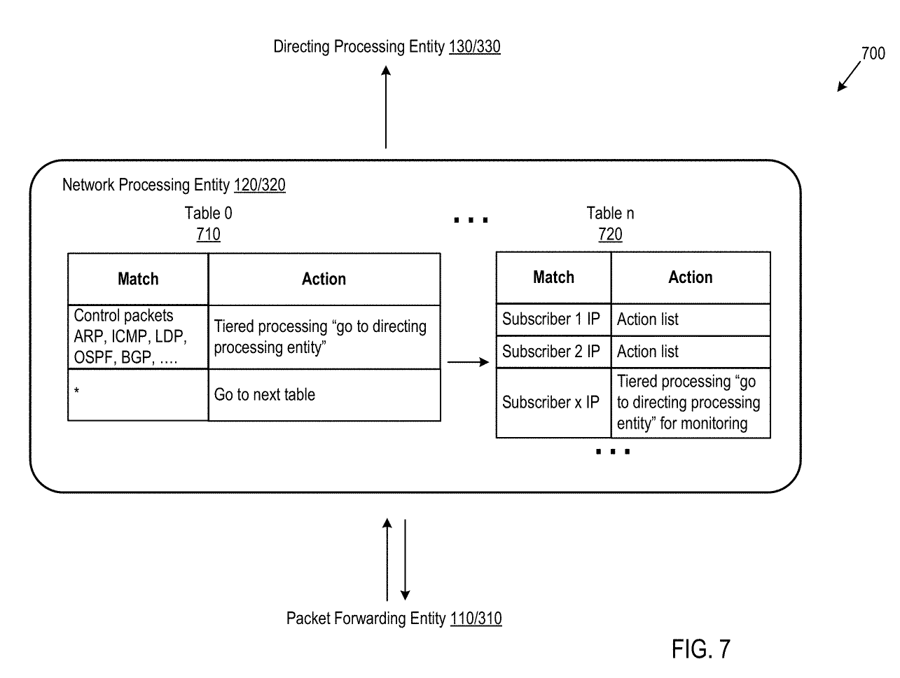

The network processing entity 120 is the second highest level that includes the NPUs 172 such as an NP-5 or NPS-400 available from Mellanox Technologies of Sunnyvale, Calif. The network processing entity 120 is characterized by L2-L7 processing and stateful forwarding tasks including stateful load balancing, flow tracking and forwarding (i.e., distributing) hundreds of millions of individual flows, application layer (L7) deep packet inspection (DPI), in-line classification, packet modification, and specialty acceleration such as, e.g., cryptography, or other task-specific acceleration. The network processing entity 120 also raises exceptions for flows that do not match existing network processing rules by passing these flows to the directing processing entity 130. Accordingly, the second level facilitates hundreds of Gb/s throughput while checking data packets against configurable network processing rules to identify which packets go to the directing processing entity 130. For example, the second level may provide some data packets to the directing processing entity 130 in response to checking the data packets against explicit rules to identify exception packets and performing a default action if there is no existing rule present to handle the data packet. Example network processing rules are set forth in FIG. 7.

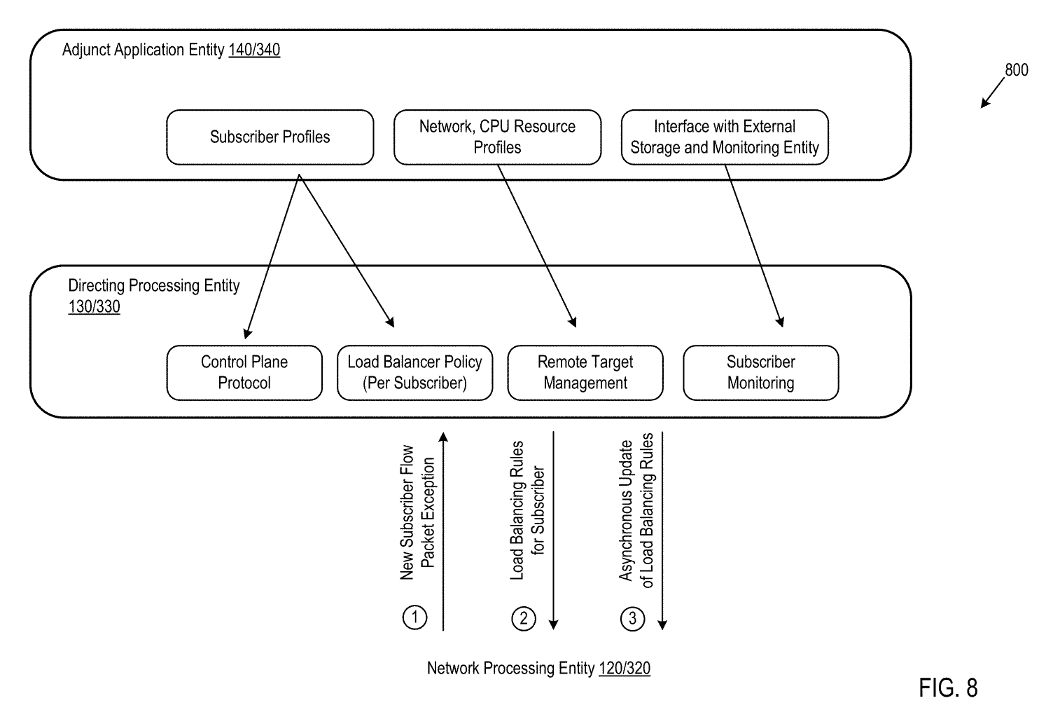

The directing processing entity 130 is the third highest level that includes the embedded SoC 182, such as a PowerPC SoC; or a CPU such as an IA Xeon CPU available from Intel Corporation of Santa Clara, Calif. For example, the TDE-500 includes a PowerPC SoC and the TDE-2000 includes a Xeon CPU. The directing processing entity 130 is characterized by coordination and complex processing tasks including control and data processing tasks. With respect to control processing tasks, which are based on directing processing rules (i.e., a policy) provided by the adjunct application entity 140, the directing processing entity 130 provisions through the control interface(s) 196 explicit (static) rules in the network processing entity 120 and the packet forwarding entity 110. Also, based on processing of exception packets, the directing processing entity 130 sets up dynamic rules in the network processing entity 120. With respect to data processing tasks, the directing processing entity 130 handles exception or head-of-flow classification of layer four (transport layer, L4) and higher layers (L4+), or other complex packet processing based on directing processing rules. Accordingly, the third level facilitates tens of Gb/s throughput while handling control processing, exception or head-of-flow classification, static rule (i.e., table) mapping, and rule instantiation into lower datapath processing tiers (see, e.g., FIG. 8).

The adjunct application entity 140 is the fourth highest (i.e., apex) level that includes the general purpose CPUs 192 configured to provide the maximum flexibility but the lowest performance relative to the other tiers. The adjunct application entity 140 is characterized by specialty (i.e., application specific) processing tasks including policy, orchestration, or application node processing tasks. More generally, the adjunct application entity provides access to this type of compute function closely coupled to the datapath via the described processing tier structures. With respect to control processing, the adjunct application entity 140 provides subscriber-, network-, or application-related policy information (i.e., rules) to the directing processing entity 130. And with respect to data processing tasks, the adjunct application entity 140 handles selected (filtered) packet processing based on adjunct application rules. Accordingly, the fourth level facilitates ones to tens of Gb/s throughput while handling—for a subset of identified flows for particular applications—data packet capture, DPI, and analytics (flexible, not fixed function), in which the data packets may flow through or terminate.

In general, the system 100 addresses at least five issues. First, it provides for highly granular flow awareness and handling within fabric infrastructure. This offers an ability to identify and process (forward/direct, tunnel/de-tunnel, load balance, analyze, or other processing tasks) many flows in groups and individually at switching fabric line rates. Second, it provides an ability to apply diverse utilities and applications to flows. For example, network engineers can leverage tools tailored for ASIC, NPU, and standard CPU environments. It also allows a broad range of processing combinations, from higher performance and low state tasks to highly stateful and lower performance tasks. Third, it provides an ability to process a high volume of flows in a single node. Handling high bandwidth I/O (i.e., greater than one Tb/s) in a single node with the granular processing mentioned above allows intelligent forwarding decisions to be at critical network junctures as opposed to closer to the service nodes (e.g., in the spine as opposed to the leaves). Fourth, it allows a blend of explicit (exact match) and algorithmic/heuristic rule-based processing. For example, it can determine network and service behavior for specific users or software applications (apps) alongside deployed default configurations for aggregate groups, which allows differentiated service and service-level agreement (SLA) treatment. Fifth, it allows selective flow-processing based on identification (ID) or rules. In other words, triggers from lower-level processing tiers determine (at higher speeds) exceptions/special treatment for specific flows/users/apps, and higher-level processing tiers handle (at lower speeds) portions of flows in greater depth/detail. For example, lower levels might use access control lists (ACLs) and flow metrics to identify traffic to send up for in-depth security analysis, such as when detecting distributed denial of service (DDoS).

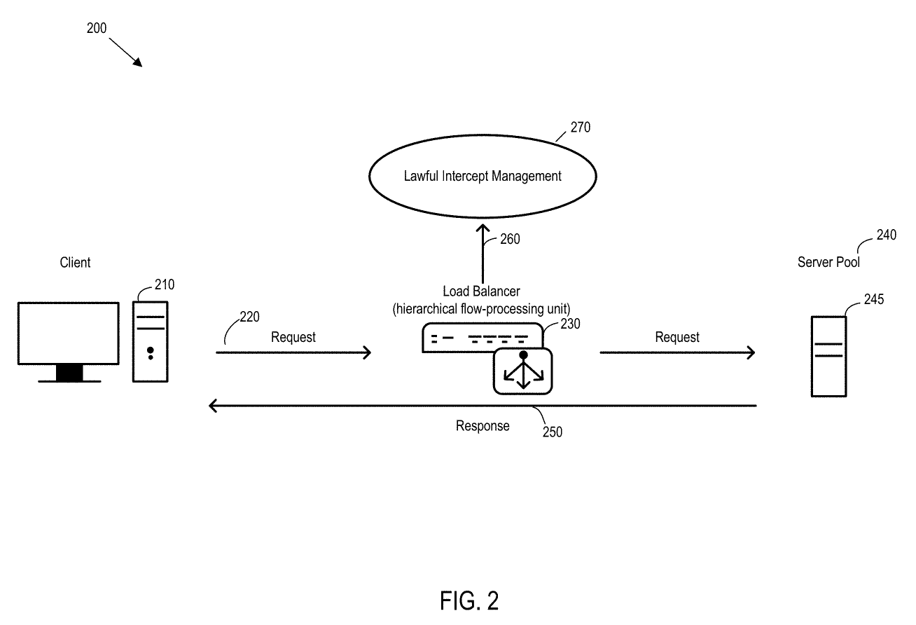

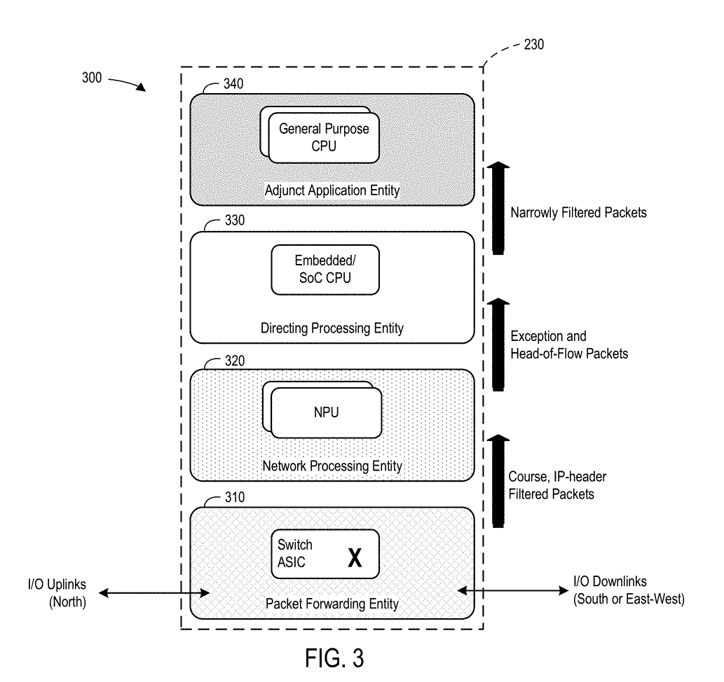

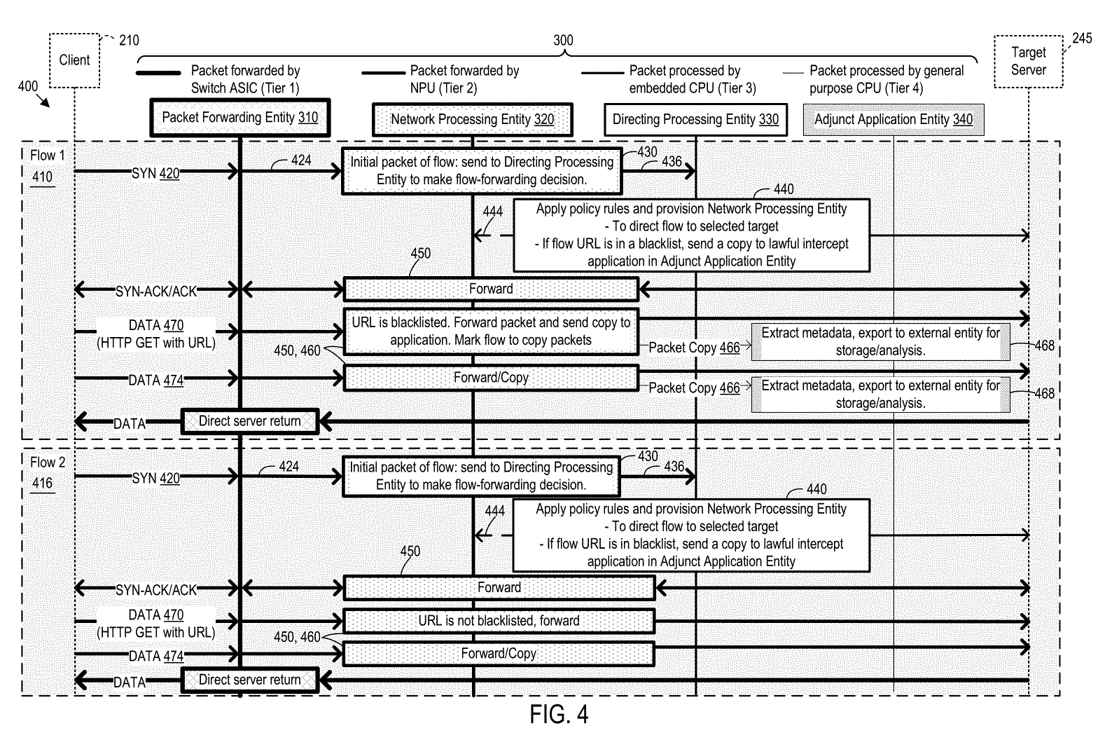

FIG. 2 shows an overview of an example load balancer scenario 200, which is explained in further detail with reference to FIGS. 3 and 4. Initially, however, FIG. 2 shows that a client 210 has flows 220 that are distributed by a load balancer 230 to a server pool 240. After selecting a target server 245, all packets for a flow are pinned to the specific target server 245. The load balancer 230 employs direct server return technology to allow response packets 250 from the server to be L3-forwarded to clients, i.e., no L2+ packet modification is employed in some embodiments. For certain flows having a blacklisted uniform resource locator (URL), the load balancer may mirror the packets 260 to a lawful intercept entity 270.

FIG. 3 shows in greater detail how four hierarchical tiers 300 are deployed in the load balancer 230 of FIG. 2. As summarized previously, each tier in the load balancer 230 corresponds to an entity optimized for processing tasks at its level in the hierarchy: a packet forwarding entity 310, a network processing entity 320, a directing processing entity 330, and an adjunct application entity 340. These entities are described below, following a paragraph describing how the entities are configured.

In some embodiments, the load balancer 230 is a monolithic entity. As such, it maintains for all of its tiers a common configuration utility. The configuration utility may accept a serial or network-based connection through which configuration settings are loaded into one or more memory storage devices so as to establish a set of programmable rules for each entity. According to one embodiment, a network appliance having hierarchical tiers maintains a web-based portal presenting a graphical user interface (GUI) through which a user modifies configuration settings so as to establish the programmable rules. In another embodiment, a user establishes a command-line-based (e.g., telnet) connection so as to configure the programmable rules. In yet another embodiment, a network appliance includes separate configuration utilities for each tier, in which case a user employs multiple connections and different ones of the multiple connections are for separately configuring different entities. In that case, the different entities may also maintain a separate memory for storing programmable rules specific to that entity. Also, the configuration settings may be modified collectively (in bulk) through, for example, uploading a configuration file; or modified individually through, for example, a simple network management protocol (SNMP) interface.

The packet forwarding entity 310 facilitates L2/L3 stateless forwarding. For example, this capability includes pass through forwarding for East-West traffic; an L3 routing function; and packets identified for load balancing (i.e., North-South traffic) are passed to the network processing entity 320 based on the destination IP set forth in the data packet. Thus, the packet forwarding entity 310 identifies a subset of the data packets for processing in the network processing entity 320 based on information present in the subset and specified by a packet forwarding rule of the programmable rules.

The network processing entity 320 facilitates stateful tracking of hundreds of millions of individual flows. The flows may be TCP, User Datagram Protocol (UDP), or some other form and are mainly tracked by user- and session-specific identifiers. This tracking capability includes mapping a packet to a flow (or flows) based on five-tuple classification and (based on a lookup of L3/L4 header fields in a subscriber flow table) a target identity; and raising exceptions to the directing processing entity 330 for flows that do not match existing flows, e.g., a TCP synchronization (SYN) packet for a new connection. More generally, the network processing entity 320 processes the subset of data packets and, in response, generates from them exceptions for processing in the directing processing entity 330, in which the exceptions correspond to selected flows specified by a network processing rule of the programmable rules.

The directing processing entity 330 facilitates control and exception processing. For example, this capability includes handling exceptions of packets for new flows, e.g., TCP connection requests; and provisioning appropriate rules in the network processing entity 320 to direct flows towards specific processing resources (e.g., a downstream CPU). More generally, the directing processing entity 330 processes the exceptions for the selected flows and, in response, instantiates in the packet forwarding entity 310 and the network processing entity 320 filter rules by which to generate filtered flows based on a directing processing rule of the programmable rules.

The adjunct application entity 340 facilitates user- or management-selected or other specialized flow-handling tasks. Virtual Machines (VMs) can be hosted on CPU(s) running instances of certain preselected target service functions that perform some service for a specific user or flow. For example, some flows could be selected for this processing based on simple classification criteria (source/destination address) and then the service function (running as a VM on an adjunct processing CPU) performs a DPI signature analysis to look for anomalies. In another embodiment, another service function, running in another VM, provides a packet capture function that receives (e.g., anomalous) packets and saves them to storage for security, monitoring, or troubleshooting. Accordingly, the adjunct application entity 340 essentially processes the filtered flows according to an adjunct processing rule of the programmable rules.

FIG. 4 shows in greater detail how the entities 300 of the load balancer 230 cooperate to process 400 a first flow 410 and a second flow 416. The following description applies generally to both flows, but where applicable, specific differences are noted.

The flows 410, 416 each start when the client 210 transmits a SYN packet 420 for establishing a new connection with the target server 245. The SYN packet 420 arrives at the packet forwarding entity 310, which then applies programmable rules for L2/L3 routing and stateless forwarding. From the packet forwarding entity 310, the SYN packet 420 is provided 424 to the network processing entity 320.

An NPU of the network processing entity 320 processes the SYN packet 420 so as to provide packet load balancing for request packets. The network processing entity 320 determines 430 that the SYN packet 420 is for an initial flow and provides 436 it to the directing processing entity 330.

In response to receiving the SYN packet 420, an embedded CPU of the directing processing entity 330 makes a flow-forwarding decision 440. The embedded CPU makes load balancing decisions for each flow. As shown in the example of FIG. 4, the directing processing entity 330 applies policy rules and provisions 444 to the network processing entity 320. For example, the network processing entity 320 is instructed to direct 450 flows to the selected target server 245 and to provide copies of blacklisted flows (e.g., the first flow 410) to the lawful intercept application 270 (FIG. 2) implemented in the adjunct application entity 340. In another embodiment, a lawful intercept application may also handle flows intended for a blacklisted target.

With respect to the first flow 410, the network processing entity 320 determines 460 whether it includes a blacklisted URL. If the flow is blacklisted, then copies are provided 466 to the adjunct application entity 340 for further analysis 468. As shown in FIG. 4, the adjunct application entity 340 may extract metadata or export information to an external entity for storage and analysis. Also, the adjunct application entity 340 may analyze request data, such as an HTTP GET request 470 or other user data 474.

FIG. 5 shows a comparison between a TDE-500 platform 500 and a TDE-2000 platform 505, which are intelligent traffic distribution systems including FlowEngine™ software. Initially, it is noted that FlowEngine provides for wire-speed flow classification inside TDE systems, increasing service throughput while leaving more capacity for VNF processing. Once the flow is classified, FlowEngine load balancing capabilities intelligently distribute the flow to the appropriate VNFs. FlowEngine also manages service chaining when a flow expects processing through a sequence of virtualized functions, while maintaining flow affinity so that subsequent packets from known flows always go to the same VNFs. These FlowEngine functions are integrated with SDN control to allow network service operators to rapidly integrate these capabilities and accelerate their NFV product programs.

The TDE-500 platform 500 affords SDN- and NFV-deployment flexibility for either distributed edge sites or core data center networks. It also provides the option to fuse together on-board SDN controller technology and value-added virtualized network services like network analytics. The TDE-500 platform 500 includes a packet forwarding entity (P.F.E.) 510, a network processing entity (N.P.E.) 516, a directing processing entity (D.P.E.) 522, and an adjunct application entity (A.A.E.) 530.

The packet forwarding entity 510 includes a 10/40/100G switch ASIC 534 (or simply, the switch 534). The switch 534 has I/O ports 540 including 12×40 Gigabit Ethernet (GE) ports, 48×10GE ports, or another suitable set of I/O ports.

The network processing entity 516 includes multiple NP-5 NPUs 544. The NPUs 544 have I/O ports 550 including 4×100GE ports, 8×40GE ports, or another suitable set of I/O ports. The NPUs 544 and the switch 534 are communicatively coupled through multiple 100GE interfaces 552 providing IP/Ethernet connections.

The directing processing entity 522 includes an SoC CPU 554, such as a PowerPC SoC. The SoC CPU 554 and the switch 534 are communicatively coupled through 40GE interfaces 556 (IP/Ethernet connections). The NPUs 544 and the SoC CPU 554 are communicatively coupled through a 10GE interface 558. (Again, bandwidth of such interfaces are examples; the design is intented to scale.)

The adjunct application entity 530 includes multiple IA Xeon CPUs 560 (e.g., a dual-Xeon-processor server), a 40G network interface controller (NIC) 562, and a 10G NIC 564. The 40G NIC 562 shares an interface 568 with the switch 534 so as to provide flows to the IA Xeon CPUs 560 through 40GE (4×10G links, i.e., IP/Ethernet connections) 570. The IA Xeon CPUs 560 use (for I/O purposes) the 10G NIC 564 that has 2×10GE ports 574.

The TDE-2000 platform 505 also includes four tiers including a packet forwarding entity (P.F.E.) 580, a network processing entity (N.P.E.) 582, a directing processing entity (D.P.E.) 584, and an adjunct application entity (A.A.E.) 586. The TDE-2000 platform 505, however, is an example in which entities may be logically separated instead of being physically separated.

In particular, note that the TDE-2000 platform 505 need not possess separate devices for handling upper-tier functionality. Instead, it may employ a more powerful single-socket Xeon CPU 588 that can handle both of the upper two tiers. In other words, the TDE-2000 platform 505 need not have an optional separate dual-Xeon-processor server 560, because its top two tiers 584, 586 are separated logically, not physically.

Logical separation may mean separation on the same CPU via a VM or (e.g., Linux) container, or a logically separated entities may be running on an external server adjunct to the TDE and connected via the switch ASIC as indicated by an optional adjunct application entity 530ᵣ. The TDE-2000 platform 505 may be communicatively coupled to the adjunct application entity 530ᵣ, which may be a separate discrete device remotely operating in close physical proximity, according to some embodiments. The word remote simply means that the adjunct application entity 530ᵣ need not be co-located in the TDE-2000 platform 505. In that sense, it may be considered a separate optional element of the TDE-2000 platform 505. This latter approach is typically more powerful and flexible. But the present design may support different, co-located approaches. In some embodiments, a discrete external server coupled with the TDE-2000 platform 505—e.g., coupled as a stack of two 1 U devices—could also provide additional adjunct processing capabilities in an architecture that is functionally similar to that of the TDE-500 platform 500, which also uses physically separate devices.

The TDE-2000 platform 505 also differs from the TDE-500 platform 500 in that the packet forwarding entity (P.F.E.) 580 includes a 10/25/100G switch ASIC 590 for I/O comprising 20×100/40GE ports, 80×25/10GE ports, or another suitable set of I/O ports; the network processing entity 582 includes multiple NPU-400s 592; optional (i.e., discrete hardware-based) DPI engine 594 and cryptography engine 596; and datapaths 598 between processors are simplified and capable of higher throughput compared to those of the TDE-500 platform 500.

FIGS. 6 and 7 show diagrams representing logical tables/functions that indicate which packets are to be sent to an upper level in the hierarchy. Thus, certain rules, entered in rows of a table, redirect a packet to a higher processing entity. Note that FIGS. 6 and 7 are not intended to show control aspect of how rules are created, an example of which is shown in FIG. 8.

FIG. 6 is a diagram 600 providing some additional context on how the packet forwarding entity 110, 310 redirects a packet having a specific destination IP address to the network processing entity 120, 320 based on a rule accessible through a table of a packet forwarding entity. In the example of diagram 600, rules are typically not granular and generally represent an aggregate flow (e.g., packets on ports, tunnels, VLANs, small list of IP addresses, and similar criteria). A first table 610 includes rules at each row for redirecting a packet, e.g., on certain ports and having a specific IP address (tunneled or otherwise), to higher processing entity. The first table 610 may also include rules to check one or more nested tables 620 including supplemental action lists (e.g., drop, forward, copy, or modify packet). This example action list represents a common set of actions, but action lists may depend a lot on the protocol used for rule management. Also, rather than maintain a single monolithic table, nesting multiple tables mitigates excessive proliferation of rules and essentially allows more sophisticated rules to be chained and readily processed. For example, with two tables, a first table may have a few rules related to destination-IP-based routing, and a second table may have millions of rules related to source-IP-based policy. Consolidating these two tables into one table, however, means that the total entries in the consolidated table would proliferate according to a cross-product problem.

FIG. 7 is a diagram 700 showing a rule example for the network processing entity 120, 320. This example shows explicit rules in the network processing entity 120, 320 that redirect control plane packets and certain subscriber flows to next higher entity. For example, a first table 710 includes in its first row search criteria for packets including Address Resolution Protocol (ARP), Internet Control Message Protocol (ICMP), Label Distribution Protocol (LDP), Open Shortest Path First (OSPF), and Border Gateway Protocol (BGP). ARP is a protocol used in connection with the IP [RFC 826], specifically IPv4, to map IP network addresses to the hardware addresses used by a data link protocol. The protocol operates below the network layer as a part of the interface between the OSI network and OSI link layer. The ICMP is a supporting protocol in the Internet protocol suite. It is used by network devices, like routers, to send error messages and operational information indicating, for example, that a requested service is not available or that a host or router could not be reached. LDP is a protocol in which routers capable of Multiprotocol Label Switching (MPLS) exchange label mapping information. Two routers with an established session are called LDP peers and the exchange of information is bi-directional. OSPF is a routing protocol for Internet Protocol (IP) networks. It uses a link state routing (LSR) algorithm and falls into the group of interior gateway protocols (IGPs), operating within a single autonomous system (AS). It is defined as OSPF Version 2 in RFC 2328 (1998) for IPv4. BGP is a standardized exterior gateway protocol designed to exchange routing and reachability information among autonomous systems (AS) on the Internet. The protocol is often classified as a path vector protocol but is sometimes also classed as a distance-vector routing protocol. A second table 720 includes actions lists performed in response to a packet matching a particular subscriber IP address.

FIG. 8 is a diagram 800 showing a rule example for the directing processing entity 130, 330 and an adjunct application entity 140, 340. This example is specific to the implementation of the load balancer 230 (FIG. 2), but the concept also applies to other implementations.

In general, the directing processing entity 130, 330 maps a high-level load balancer policy from the adjunct application entity 140, 330 to corresponding rules created for the network processing entity 120, 320 and for the packet forwarding entity 110, 310. The polices includes defining load balancing groups, distribution algorithms, failover mechanism, target monitoring, and other types of policies. To implement a policy, the directing processing entity 130, 330 provides subscriber-specific packet distribution rules to the network processing entity 120, 320, handles control plane packets, checks liveliness of remote targets, makes failover decisions, and monitors packets for certain subscribers as request from a higher entity.

The adjunct application entity 140, 340 maintains repository of subscriber and network profiles. For load balancing, it pushes a subscriber's load balancing profile to the directing processing entity 130, 330.

As an aside, skilled persons will appreciate that the packet forwarding entity 110, 310 is not indicated in FIG. 8. This is so because the example use case is that of a load balancer, in which case the directing processing entity 130, 330 is responsible for adding rules in the packet forwarding entity 110, 310. But the rules added would not directly relate to a load balancing policy—they would typically relate to L2/L3 routing policies and specifics. Accordingly, for purposes of conciseness, the packet forwarding entity 110, 310 is omitted in FIG. 8.

According to some embodiments, each tier—irrespective of whether it is logically or physically separated—may be independently developed using a different technology base or separate roadmap for future enhancements. Furthermore, software modules or circuitry may link the processing levels, and allow independent development and scaling of them. Thus, embodiments described herein may be implemented into a system using any suitably configured hardware and software. Moreover, various aspects of certain embodiments may be implemented using hardware, software, firmware, or a combination thereof. A tier, entity, or level may refer to, be part of, or include an ASIC, electronic circuitry, a processor (shared, dedicated, or group), or memory (shared, dedicated or group) that execute one or more software or firmware programs, a combinational logic circuit, or other suitable components that provide the described functionality.

A software module, component, or the aforementioned programmable rules may include any type of computer instruction or computer executable code located within or on a non-transitory computer-readable storage medium. These instructions may, for instance, comprise one or more physical or logical blocks of computer instructions, which may be organized as a routine, program, object, component, data structure, text file, or other instruction set, which facilitates one or more tasks or implements particular abstract data types. In certain embodiments, a particular software module, component, or programmable rule may comprise disparate instructions stored in different locations of a computer-readable storage medium, which together implement the described functionality. Indeed, a software module, component, or programmable rule may comprise a single instruction or many instructions, and may be distributed over several different code segments, among different programs, and across several computer-readable storage media. Some embodiments may be practiced in a distributed computing environment where tasks (e.g., adjunct processing) are performed by a remote processing device linked through a communications network.

A memory device may also include any combination of various levels of non-transitory machine-readable memory including, but not limited to, ROM having embedded software instructions (e.g., firmware), random access memory (e.g., DRAM), cache, buffers, etc. In some embodiments, memory may be shared among the various processors or dedicated to particular processors.

The term circuitry may refer to, be part of, or include an ASIC, an electronic circuit, a processor (shared, dedicated, or group), or memory (shared, dedicated, or group) that execute one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

Skilled persons will understand that many changes may be made to the details of the above-described embodiments without departing from the underlying principles of the invention. For example, levels and associated functions are embodied into a single appliance architecture, monolithic in its appearance and with respect to its network instantiation. In other embodiments, it may be modular in its internal construction. Also, the aforementioned throughput rates of the various embodiments are provided by way of example only. Thus, the scope of the present invention should, therefore, be determined only by claims.

1. A system having hierarchical flow-processing tiers in which an upper processing level handles increasingly computationally intensive flow processing relative to a lower processing level and flow-processing throughput is decreasingly accelerated at the upper processing level relative to the lower processing level such that computational intensity and volume are inversely related to each other across the hierarchical flow-processing tiers of the system, comprising:
one or more memory devices to store programmable rules by which to manage processing of data packets at first, second, third, and fourth processing levels of the hierarchical flow-processing tiers; and
one or more processors to provide a packet forwarding entity acting as the first processing level, a network processing entity acting as the second processing level, a directing processing entity acting as the third processing level, and an adjunct application entity acting as the fourth processing level, the one or more processors configured to:
analyze, in the packet forwarding entity, the data packets to provide layer two (L2) or layer three (L3) (L2/L3) stateless data packet forwarding at line rates and identify a subset of the data packets for processing in the network processing entity based on information present in the subset and specified by a packet forwarding rule of the programmable rules;
process, in the network processing entity, the subset of data packets and, in response, generate from them exceptions for processing in the directing processing entity, the exceptions corresponding to selected flows specified by a network processing rule of the programmable rules;
process, in the directing processing entity, the exceptions for the selected flows and, in response, instantiate in the packet forwarding entity and the network processor entity filter rules by which to generate filtered flows based on a directing processing rule of the programmable rules; and
process, in the adjunct application entity, the filtered flows according to an adjunct processing rule of the programmable rules.

2. The system of claim 1, in which the one or more processors comprise a programmable network switch corresponding to the packet forwarding entity.

3. The system of claim 1, in which the one or more processors comprise a network processing unit (NPU) corresponding to the network processing entity.

4. The system of claim 1, in which the one or more processors comprise an embedded system on a chip (SoC) central processing unit (CPU) corresponding to the directing processing entity.

5. The system of claim 1, in which the one or more processors comprise a central processing unit (CPU) compute server corresponding to the adjunct processing entity.

6. The system of claim 1, in which the one or more processors comprise a central processing unit (CPU) corresponding to the directing processing entity and the adjunct processing entity.

7. The system of claim 1, further comprising:
a load balancer including the packet forwarding entity, the network processing entity, and the directing processing entity; and
an external sever comprising the adjunct application entity.

8. A network appliance comprising the system of claim 1.

9. A system having hierarchical flow-processing tiers in which an upper processing level handles increasingly computationally intensive flow processing relative to a lower processing level and flow-processing throughput is decreasingly accelerated at the upper processing level relative to the lower processing level such that computational intensity and volume are inversely related to each other across the hierarchical flow-processing tiers of the system, comprising:
a programmable network switch configured to perform layer two (L2) or layer three (L3) (L2/L3) stateless data packet forwarding at line rates for a subset of data packets;
a network processing unit (NPU), communicatively coupled to the programmable network switch, configured to receive from the programmable network switch the subset of data packets and raise therefrom exceptions for selected flows;
a first processor, communicatively coupled to the NPU, configured to receive from the NPU the exceptions for selected flows, instantiate filtering rules for the programmable network switch and the NPU, and filter the selected flows; and
a second processor, communicatively coupled to the first processor, configured to perform application specific processing tasks including policy, orchestration, or application node processing tasks on filtered flows and provide control information to the first processor.

10. The system of claim 9, in which the programmable network switch establishes a first, lowest level of the hierarchical flow-processing tiers, the first level including a switching application-specific integrated circuit (ASIC), input-output (I/O) uplinks, and I/O downlinks.

11. The system of claim 9, in which the NPU establishes a second level of the hierarchical flow-processing tiers for layer two through layer seven (L2-L7) processing and stateful forwarding tasks.

12. The system of claim 9, in which the first processor comprises an embedded system on a chip (SoC) that establishes a third level of the hierarchical flow-processing tiers for control and data processing tasks.

13. The system of claim 9, in which the second processor comprises a central processing unit (CPU) that establishes a fourth, highest level of the hierarchical flow-processing tiers for application specific processing tasks including policy, orchestration, or application node processing tasks.

14. The system of claim 13, further comprising a remotely located server including the CPU.

15. A method, performed by a hierarchical flow-processing system of processing tiers, of flow-aware processing, the method comprising:
performing in a first tier of the hierarchical flow-processing tiers layer two (L2) or layer three (L3) (L2/L3) stateless data packet forwarding at line rates based at least in part on a first set of instructions provided by one or more upper-level tiers of the hierarchical flow-processing tiers;
performing in a second tier of the hierarchical flow-processing tiers layer two through layer seven (L2-L7) processing and stateful forwarding tasks based at least in part on a second set of instructions provided by the one or more upper-level tiers of the hierarchical flow-processing tiers;
performing in a third tier of the hierarchical flow-processing tiers control and data processing tasks, the control processing tasks, including provisioning rules in the first and second tiers based on a policy provided by the one or more upper-level tiers of the hierarchical flow-processing tiers, and the data processing tasks including handling exception or head-of-flow classification of layer four (L4) and higher layers (L4+); and
performing in a fourth tier of the hierarchical flow-processing tiers application specific processing tasks including policy, orchestration, or application node processing tasks including providing in the fourth tier data packet capture, deep packet inspection, and analytics, and providing to the third tier the policy so as to control flows based on subscriber-, network-, or application-related information.

16. The method of claim 15, further comprising providing, from the first tier to the second tier, data packets in response to the data packets possessing preselected destination internet protocol (IP), media access control (MAC), or virtual local area network (VLAN) information at a data link layer.

17. The method of claim 15, further comprising:
mapping, in the second tier, a packet to a flow based on a five-tuple classification and a target identity; and
raising to the third tier exceptions for flows that do not match existing flows.

18. The method of claim 17, further comprising:
processing, in the third tier, the exceptions; and
deploying, from the third tier to the second tier, dynamic load balancing rules based on the exceptions.

19. The method of claim 15, further comprising capturing, in the fourth tier, anomalous packets detected in the third tier.
